(19) United States
(12) Patent Application Publication
(10) Pub. No.: US 2015/0003536 A1
(43) Pub. Date: Jan. 1, 2015

(54) METHOD AND APPARATUS FOR USING AN ULTRA-LOW DELAY MODE OF A HYPOTHETICAL REFERENCE DECODER

(71) Applicant: THOMSON LICENSING, Issay de Moulineaux (FR)

(72) Inventors: Lihua Zhu, San Jose, CA (US); Richard Edwin Goedeken, Santa Clarita, CA (US); Garrett James Borunda, Coronado, CA (US)

(73) Assignee: THOMSON LICENSING, ISsy de Moulineaux (FR)

(21) Appl. No.: 14/375,009

(22) PCT Filed: Dec. 20, 2012
(86) PCT No.: PCT/US2012/070943

§ 371 Date: Jul. 28, 2014

Related U.S. Application Data
(60) Provisional application No. 61/596,519, filed on Feb. 8, 2012.

(51) Int. Cl. H04N 19/15; H04N 19/152

(52) U.S. Cl. CPC H04N 19/00187; H04N 19/00193
USPC 375/240.25

(57) ABSTRACT

A method and apparatus are provided for using an ultra-low delay mode of a hypothetical reference decoder. The method is provided in a video decoder, and includes defining (320) a hypothetical reference decoder timing model to specify timing constraints based on an arrival time and a removal time of hypothetical reference decoder access units included in a video bitstream with respect to a hypothetical reference decoder buffer. The hypothetical reference decoder access units are selected from among a slice access unit and a picture access unit. The method also includes evaluating (325) the video bitstream for conformance to requirements of the hypothetical reference decoder buffer based on the hypothetical reference decoder timing model.

### CROSS-REFERENCE TO RELATED APPLICATIONS

This application claims the benefit of U.S. Provisional Application Ser. No. 61/596,519, filed Feb. 8, 2012, which is incorporated by reference herein in its entirety.

### TECHNICAL FIELD

The present principles relate generally to video encoding and decoding and, more particularly, to a method and apparatus for using an ultra-low delay mode of a hypothetical reference decoder.

### BACKGROUND

Hypothetical reference decoder (HRD) conformance is a normative part of most video compression standards. HRD presents a set of requirements on the bitstream. An HRD verifier is software and/or hardware used to verify the conformance of a bitstream to the set of requirements by examining the bitstream, detecting whether any HRD errors exist and, if so, reporting such errors.

In video coding standards and recommendations, such as the International Organization for Standardization/International Electrotechnical Commission (ISO/IEC) Moving Picture Experts Group-1 (MPEG-1) Standard, the ISO/IEC MPEG-2 Standard, the ISO/IEC MPEG-4 Standard, the International Telecommunication Union, Telecommunication Sector (ITU-T) H.263 Recommendation, the ISO/IEC MPEG-4 Part 10 Advanced Video Coding (AVC) Standard/ITU-T H.264 Recommendation (hereinafter the “MPEG-4 AVC standard”), and the ISO/IEC MPEG—High Efficiency Video Coding (HVEC) Standard/(hereinafter the “HEVC Standard” or simply “HEVC”), a bitstream is determined to be conformant if the bitstream adheres to the syntactical and semantic rules embodied in the standard and/or recommendation. One such set of rules takes the form of a successful flow of the bitstream through a mathematical or hypothetical model of the decoder, which is conceptually connected to the output of an encoder and receives the bitstream from the encoder. Such a model decoder is referred to a hypothetical reference decoder (HRD) in some standards or the video buffer verifier (VBV) in other standards. In other words, the HRD specifies rules that bitstreams generated by a video encoder must adhere to for such an encoder to be considered conformant under a given standard. HRD is a normative part of most video coding standards and, hence, any bitstream under a given standard has to adhere to the HRD rules and constraints, and a real decoder can assume that such rules have been conformed with and such constraints have been met.

An ultra-low delay application has been proposed for the hypothetical reference model in the International Organization for Standardization/International Electrotechnical Commission (ISO/IEC) Moving Picture Experts Group—High Efficiency Video Coding (HVEC) Standard (hereinafter the “HEVC Standard”). In a prior art approach relating to the ultra-low delay application, a tree block was introduced for use instead of a picture for the HRD operation. A picture is conceptually split into some groups. Each group includes equal numbers of tree blocks. The group is signaled in the buffer period of a video utility information (VUI) message. In the prior art approach, the removal time of i-th group in picture n was redefined as follows:

tr(n,i)=tr(n−1)+(tr(n)−tr(n−1))*i/M

where tr(n,i) is the removal time of the ith sub picture of the n-th picture, and M is the number of sub pictures in a picture.

The preceding prior art approach makes it difficult to implement the current HRD specified in the HEVC Standard. For example, the prior art approach does not consider the timing model for the arrival time and the earlier arrival time. Moreover, the constraint arrival time model is not guaranteed by the preceding prior art approach. Additionally, the preceding prior art approach also added a constraint for the end bin in the context-adaptive binary arithmetic coding (CABAC) which will result in performance loss.

### SUMMARY

These and other drawbacks and disadvantages of the prior art are addressed by the present principles, which are directed to a method and apparatus for using an ultra-low delay mode of a hypothetical reference decoder.

According to an aspect of the present principles, there is provided a method in a video decoder. The method includes defining a hypothetical reference decoder timing model to specify timing constraints based on an arrival time and a removal time of hypothetical reference decoder access units included in a video bitstream with respect to a hypothetical reference decoder buffer. The hypothetical reference decoder access units are selected from among a slice access unit and a picture access unit. The method also includes evaluating the video bitstream for conformance to requirements of the hypothetical reference decoder buffer based on the hypothetical reference decoder timing model.

According to another aspect of the present principles, a video decoder is provided. The video decoder includes a hypothetical reference decoder timing model defined to specify timing constraints based on an arrival time and a removal time of hypothetical reference decoder access units included in a video bitstream with respect to a hypothetical reference decoder buffer. The hypothetical reference decoder access units are selected from among a slice access unit and a picture access unit. The video decoder also includes a hypothetical reference decoder requirements conformance evaluator for evaluating the video bitstream for conformance to requirements of the hypothetical reference decoder buffer based on the hypothetical reference decoder timing model.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary video encoder 100 to which the present principles may be applied, in accordance with an embodiment of the present principles;

FIG. 2 shows an exemplary video decoder 200 to which the present principles may be applied, in accordance with an embodiment of the present principles;

FIG. 3 shows an exemplary method 300 for using an ultra-low delay mode of a hypothetical reference decoder, in accordance with an embodiment of the present principles; and

FIG. 4 shows an exemplary buffer arrangement 400 to which the present principles can be applied, in accordance with an embodiment of the present principles.

### DETAILED DESCRIPTION

The present principles are directed to a method and apparatus for using an ultra-low delay mode of a hypothetical reference decoder.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

As noted above, the present principles are directed to methods and apparatus for using an ultra-low delay mode of a hypothetical reference decoder.

For purposes of illustration and description, examples are described herein in the context of improvements over the International Organization for Standardization/International Electrotechnical Commission (ISO/IEC) Moving Picture Experts Group—High Efficiency Video Coding (HEVC) Standard (hereinafter the “HEVC Standard”), using the HEVC Standard as the baseline for our description and explaining the improvements and extensions beyond the HEVC Standard. However, it is to be appreciated that the present principles are not limited solely to the HEVC Standard and/or extensions thereof (such as, for example, MPEG-HEVC Scalable Video Coding (SVC) and Multi-view Video Coding (MVC)). Given the teachings of the present principles provided herein, one of ordinary skill in this and related arts would readily understand that the present principles are equally applicable and would provide at least similar benefits when applied to extensions of other standards, or when applied and/or incorporated within standards not yet developed. That is, it would be readily apparent to those skilled in the art that other standards may be used as a starting point to describe the present principles and their new and novel elements as changes and advances beyond that standard or any other. It is to be further appreciated that the present principles also apply to video encoders and video decoders that do not conform to standards, but rather confirm to proprietary definitions.

Regarding the terms “compliance” and “conformance” as used herein, we note that compliance is an informal term intended to represent that the coded bitstream satisfies the specification of a given coding standard (or recommendation, proprietary approach, etc.) while conformance is a formal term intended to represent that the coding system assuredly generates bitstreams which can satisfy the specification of a given coding standard (or recommendation, proprietary approach, etc.).

It is to be appreciated that one of ordinary skill in the art can implement the present principles in various configurations. For example, the present principles can be implemented in a stand-alone fashion in a video encoder. Such a video encoder can, for example, only include a video encoder, or can optionally include a video decoder therein. Moreover, the present principles can be implemented such that a corresponding decoder separate from an encoder can provide feedback to the encoder in order to implement the present principles. These and other configurations are readily determined by one of ordinary skill in the art, given the teachings of the present principles provided herein.

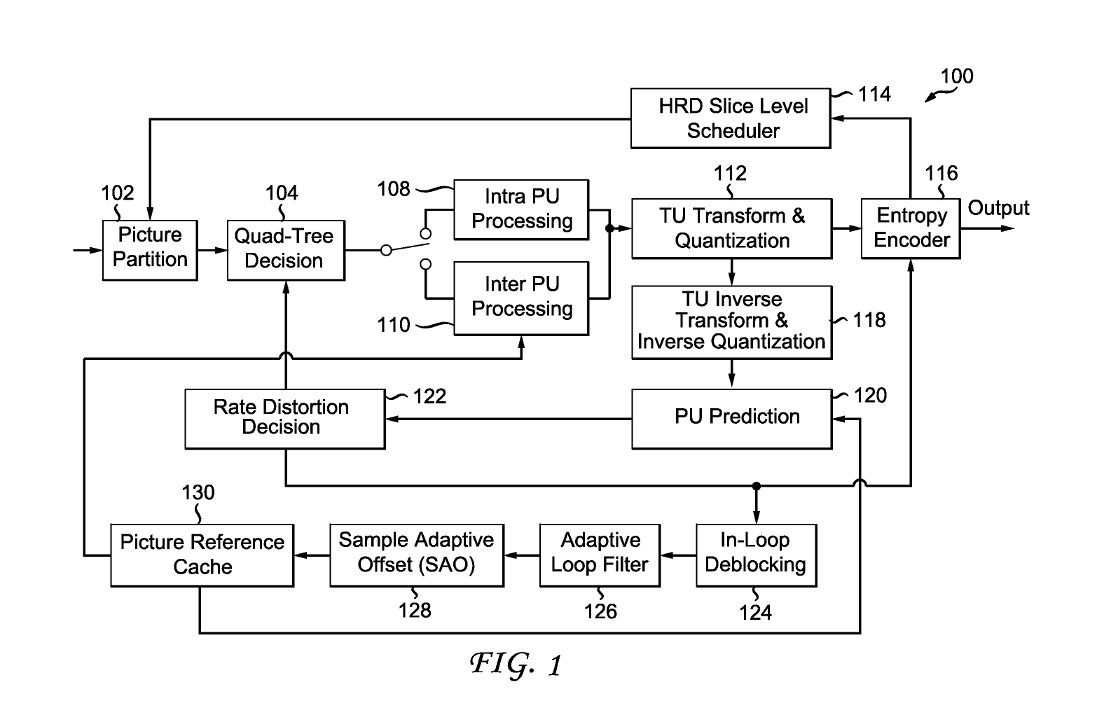

Turning to FIG. 1, an exemplary video encoder to which the present principles may be applied is indicated generally by the reference numeral 100. The video encoder 100 includes a picture partitioning device 102 having an output connected to a first input of a quad-tree decision device 104. An output of the quad-tree decision device 104 is selectively connected to an input of an intra PU processor 108 or a first input of an inter PU processor 110. Respective outputs of the intra PU processor 108 and the inter PU processor 110 are connected in signal communication with an input of a TU transformer and quantizer 112. A first output of the TU transformer and quantizer is connected in signal communication with a first input of an entropy encoder 116. A first output of the entropy encoder 116 is connected in signal communication with an input of a HRD slice level scheduler 114. An output of the HRD slice level scheduler 114 is connected in signal communication with a second input of the picture partitioning device 102. A second output of the TU transformer and quantizer 112 is connected in signal communication with an input of a TU inverse transformer and inverse quantizer 118. An output of the TU inverse transformer and quantizer 118 is connected in signal communication with a first input of a PU predictor 120. An output of the PU predictor 120 is connected in signal communication with an input of a rate distortion decision device 122. A first output of the rate distortion decision device 122 is connected in signal communication with a second input of the quad-tree decision device 104. A second output of the rate distortion decision device 122 is connected in signal communication with a second input of the entropy encoder 116 and an input of an in-loop deblocking filter 124. An output of the in-loop deblocking filter 124 is connected in signal communication with an input of an adaptive loop filter 126. An output of the adaptive loop filter 126 is connected in signal communication with an input of a sample adaptive offset (SAO) device 128. An output of the sample adaptive offset (SAO) device 128 is connected in signal communication with an input of a picture referencing cache 130. A first output of the picture referencing cache 130 is connected in signal communication with a second input of the inter PU processor 110. A second output of the picture referencing cache 130 is connected in signal communication with a second input of the PU predictor 120. A second output of the entropy encoder 116 is available as an output of the video encoder 100. A first input of the picture partitioning device 102 is available as an input of the video encoder 100.

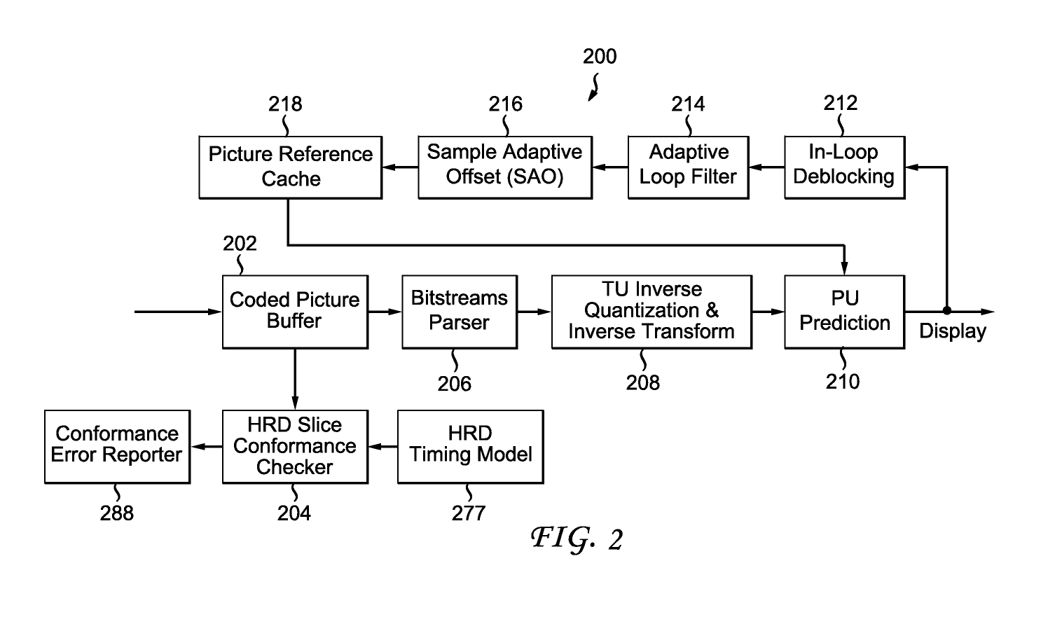

Turning to FIG. 2, an exemplary video decoder to which the present principles may be applied is indicated generally by the reference numeral 200. The video decoder 200 includes a coded picture buffer (CPB) 202 having a first output connected in signal communication with a first input of a HRD slice conformance checker 204 and having a second output connected in signal communication with an input of a bitstream parser 206. An output of the HRD slice conformance checker 204 is connected in signal communication with an input of a HRD error reporter 288. A HRD timing model 277 has an output connected in signal communication with a second input of the HRD slice conformance checker 204. An output of the bitstream parser 206 is connected in signal communication with an input of a TU inverse quantizer and inverse transformer 208. An output of the TU inverse quantizer and inverse transformer 208 is connected in signal communication with a first input of a PU predictor 210. An output of the PU predictor 210 is connected in signal communication with an input of an in-loop deblocking filter 212. An output of the in-loop deblocking filter 212 is connected in signal communication with an input of an adaptive loop filter 214. An output of the adaptive loop filter 214 is connected in signal communication with an input of a sample adaptive offset (SAO) device 216. An output of the sample adaptive offset (SAO) device 216 is connected in signal communication with an input of a picture reference cache 218. An output of the picture reference cache 218 is connected in signal communication with a second input of the PU predictor 210. An input of the coded picture buffer (CPB) 202 is available as an input of the video decoder 200. The output of the PU predictor 210 is available as an output of the video decoder 200.

Regarding the HRD timing model 277, while the same is shown as a separate element from the HRD slice conformance checker 204, in an embodiment, the HRD timing model 277 can be incorporated with the HRD slice conformance checker 204. These and other variations of the element of FIG. 2 (as well as those of FIG. 1) are readily contemplated by one of ordinary skill in the art, given the teachings of the present principles provided herein.

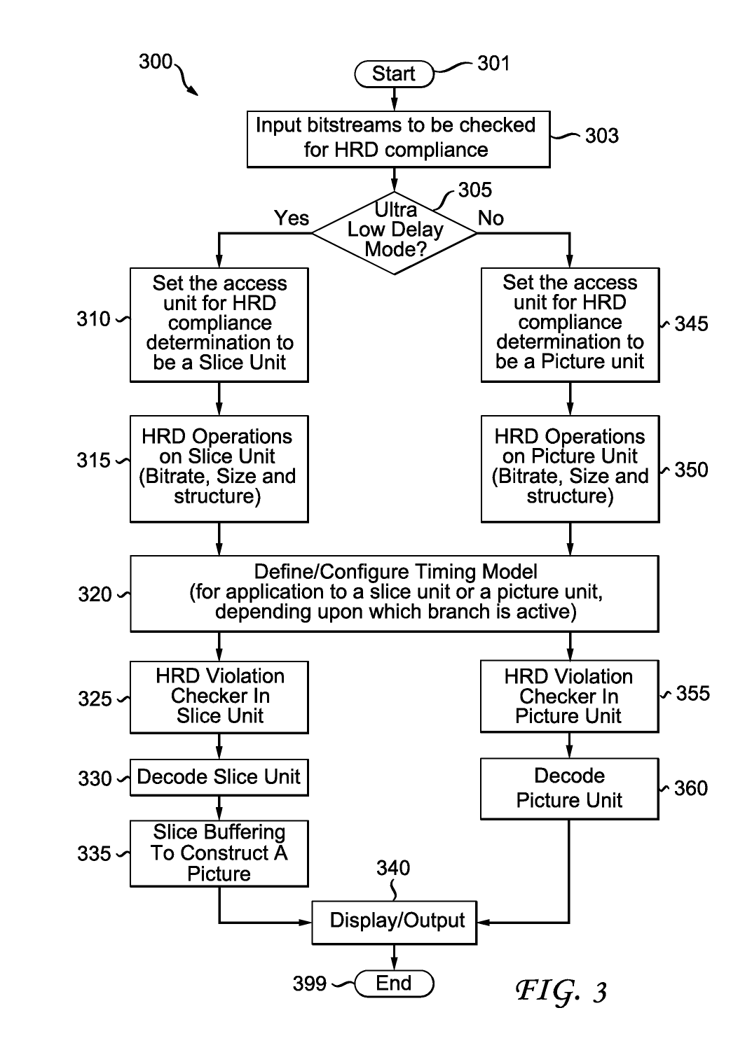

Turning to FIG. 3, an exemplary method for using an ultra-low delay mode of a hypothetical reference decoder is indicated generally by the reference numeral 300. The method 300 includes a start block 301 that passes control to a function block 303. The function block 303 receives input bitstreams (e.g., video, audio, and metadata) to be checked for HRD compliance, and passes control to a decision block 305. The decision block 305 determines whether or not the current mode is the ultra low delay mode. If so, then control is passed to a function block 310. Otherwise, control is passed to a function block 345.

The function block 310 sets the access unit for HRD conformance determination to be a slice unit (HRD unit), and passes control to a function block 315. The function block 315 performs HRD operations on slice units (to determine, e.g., bitrate, size, and structure), and passes control to a function block 320. The function block 320 defines/configures the timing model for application to the access unit set by the function blocks 310 and 345, and passes control to one of (depending upon which branch off of decision block 305 is active) a function block 325 and a function block 355. The function block 325 checks for HRD violations in the slice units, and passes control to a function block 330. The function block 330 decodes the slice units, and passes control to a function block 335. The function block 335 performs slice buffering to construct one or more pictures, and passes control to a function block 340. The function block 340 displays/outputs the pictures, and passes control to an end block 399.

The function block 345 sets the access unit for HRD conformance determination to be a picture unit (HRD unit), and passes control to the function block 350. The function block 350 performs HRD operations on picture units (to determine, e.g., bitrate, size, and structure), and passes control to the function block 320. The function block 355 checks for HRD violations in the picture units, and passes control to a function block 360. The function block 360 decodes the picture units, and passes control to the function block 340.

Referring to the decision block 305, it is determined whether or not a particular flag is present in the HRD syntax included in one or more of the input bitstreams. Thus, the HRD conformance checker can know whether the current mode is the ultra-low delay mode based on the flag. In accordance with an embodiment of the present principles, we modify the syntax E.1.1 (of the MPEG-4 AVC Standard) as follows:

if( nal_hrd_parameters_present_flag ||
vcl_hrd_parameters_present_flag )

low_delay_hrd_flag

where low_delay_hrd_flag specifies the HRD operational mode as specified in Annex C of the MPEG-4 AVC Standard. When fixed_pic_rate_flag is equal to 1, low_delay_hrd_flag shall be equal to 0. When low_delay_hrd_flag is not present, its value is inferred to be equal to 1−fixed_pic_rate_flag. When low_delay_hrd_flag is equal to 2, it indicates the current bitstream can support ultra-low delay decoding, and the HRD operation should be based on a slice instead of a picture.

In the embodiment, we add the ultra low delay mode based on the MPEG-4 AVC/264 Standard for use with respect to the HEVC Standard, e.g., low_delay_hrd_flag to support the ultra-low delay mode. If the flag is detected by decision block 305, the HRD conformance determination will be performed using an access unit based on a slice (i.e., as per the function block 310) as the checking unit, as opposed to using an access unit based on picture (i.e., as per the function block 345). It is to be noted that decision block 305 includes two branches, one of which is selected based on the detection of the aforementioned flag. Regarding function blocks 315 and 350, the same determine statistics of the selected access unit, i.e., either a slice unit or a picture unit, depending upon the active branch. Such statistics may include, but are not limited to, bitrate, size (which can be the size of access units), a NAL unit, a slice unit, and structure (such as a group of pictures (GOP), a primary picture, etc.).

Regarding function block 320, in an embodiment, we can use the same timing model as that used for an access unit based on a picture (e.g., such as in the MPEG-4/H.264 Standard), but the timing unit (access unit) of the timing model is based on a slice when the slice branch is active.

Further regarding the function block 320, in an embodiment, the timing model may be dynamically defined/configured for application to the selected access unit (slice access unit or picture access unit). In another embodiment, a respective timing model is already defined for each type of access unit, and the relevant one is selected for use with respect to checking for HRD violations (as per the function blocks 325 and 355) depending upon which branch is active.

Also regarding the function blocks 320 and 325, the timing model can be selectively configured to employ a variable bitrate or a constant bitrate to determine whether the bitstreams conform to the requirements of the HRD. That is, the hypothetical reference decoder timing model determines whether the bitstreams conform to the requirements of the hypothetical reference decoder buffer under a variable bit rate test case and/or a constant bit rate test case. The test cases relate to the type of encoding used to encode the evaluated bitstreams. Moreover, in an embodiment, a leaky bucket technique can be employed to determine whether the bitstreams conform to the requirements of the HRD. Such leaky bucket technique is used in, e.g., packet switched computer networks to check that data transmissions, in the form of packets, conform to defined limits on bandwidth and burstiness.

The HRD violation checker can then be based on a slice as per the function block 325, as opposed to being based on a picture as per function block 355. In an embodiment, the same formula (s) as that used for pictures in the MPEG-4 AVC/H.264 Standard can be used for HRD violation checking, but in consideration of a slice unit when the slice branch is active. Thus, the function blocks 325 and 355 render an HRD violation determination based on the application of the timing model to the selected access units.

Referring to the function block 330, since decoding is based on a slice instead of a picture, a slice buffer/memory will store the temporary slices as per the function block 335 to construct a picture, and then we can output the picture(s) or display it as per the function block 340.

Further regarding the modified syntax E.1.1, the low_delay_hrd_flag in the current working draft of HEVC only indicates the no-delay and delay mode, and we extend the low_delay_hrd_flag to support ultra-low delay mode. So the low_delay_hrd_flag have three meanings, and when low_delay_hrd_flag is 0 or 1, it still keeps the same functionalities as the ITU H.264. When the low_delay_hrd_flag is 2, and it means that the current bitstreams support ultra-low delay mode. And then, all of HRD operations should be based on slice unit instead of picture unit. The timing model and HRD violation checker are also based on slice unit.

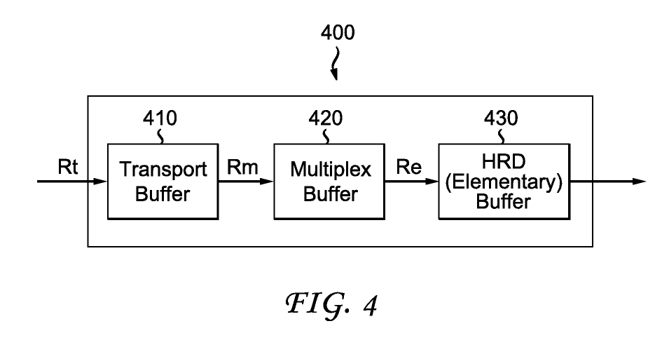

Turning to FIG. 4, an exemplary buffer arrangement to which the present principles can be applied is indicated generally by the reference numeral 400. In an embodiment, the buffer arrangement 400 is conceptually connected to an output of an encoder. Alternatively, the buffer arrangement 400 can be implemented with respect to a decoder side, for example, within a HRD conformance checker of the decoder. Of course, other arrangements can be used, while maintaining the spirit of the present principles. The buffer arrangement 400 includes a transport buffer 410 having an output connected in signal communication with an input of a multiplex buffer 420. An output of the multiplex buffer 420 is connected in signal communication with an input of a hypothetical reference decoder (elementary) buffer 430. An input of the transport buffer 410 is available as an input of the buffer arrangement 400. An output of the hypothetical reference decoder (elementary) buffer 430 is available as an output of the buffer arrangement 400. In FIG. 4, Rt denotes the bitrate entering the transport buffer, Rm denotes the bit rate entering the multiplex buffer, and Re denotes the bit rate entering the HRD buffer (also called elementary buffer). We note that the HRD elementary buffer 430 is referred to herein as simply “elementary buffer” in short.

We propose an ultra-low delay mechanism for the ultra-low delay mode requested by the broadcasting industry in the fifth JCT-VC meeting. Such ultra-low delay has been strongly supported by service providers regarding interactive video editing or browsing. Ultra-low delay indicates that the total delay operation on the decoded picture including transmission time via one or more channels, and the times needed to enter a buffer and be retrieved from the buffer for decoding should be less than 30 ms-100 ms. That is, ultra-low delay indicates the decoding time of a picture is less than one frame period (1/frame per second). Considering the constraint arrival model of the HRD in the MPEG-4 AVC Standard or the HEVC Standard, the minimum constraint for the decoding time should be one frame period, so the HRD in the MPEG-4 AVC Standard is invalid to decode a frame with less than one frame period. The hypothetical reference decoder model in the International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”) does not support this kind of case. Thus, a hypothetical reference decoder model with the ultra-low delay for an editing purpose in broadcasting should be created and integrated into the HEVC Standard.

In accordance with an embodiment of the present principles, we propose a new scheme to design the HRD. In the current version of the HEVC Standard, an access unit is used as the basic operation unit for the timing model. Since an access unit is based on the picture level, an access unit will cause a significant delay for the HRD. Thus, in accordance with an embodiment of the present principles, we changed the basic operation unit of an access unit into a HRD unit. A HRD unit can be, for example, a slice or a network abstraction layer (NAL) unit, and can be flexible enough to be removed from the buffer with the shortest delay.

The HRD is characterized by the channel bit rate, the buffer size, the initial decoder removal delay as well as the HRD unit removal delay. The HEVC Standard also describes the definition and operation of an initial arrival time of a slice for the HRD. The initial arrival time tₐᵢ of the HRD unit is derived as follows:

The HRD may be initialized at any one of the buffering period SEI messages. Prior to the initialization, the CPB is empty.

The variable t, is derived as follows and is called a clock tick:

t_{c}=num_units_in_tick÷time_scale (C.1)

It is to be noted that after initialization, the HRD is not initialized again by any subsequent buffering period SEI messages.

Each HRD unit is referred to as HRD unit n, where the number n identifies the particular HRD unit. The HRD unit that is associated with the buffering period SEI message that initializes the CPB is referred to as HRD unit 0. The value of n is incremented by 1 for each subsequent HRD unit in decoding order.

The time at which the first bit of HRD unit n begins to enter the coded picture buffer (CPB) is referred to as the initial arrival time tₐᵢ(n).

The initial arrival time of HRD units is derived as follows:

If the HRD unit is HRD unit 0, tₐᵢ(0)=0,

Otherwise (the HRD unit is HRD unit n with n>0), and the following applies:
If cbr_flag[SchedSelIdx] is equal to 1, then the initial arrival time for HRD unit n, is equal to the final arrival time (which is derived below) of HRD unit n−1, i.e.:

tₐᵢ(n)=t_{af}(n−1) (C-2)
Otherwise (cbr_flag[SchedSelIdx] is equal to 0), the initial arrival time for HRD unit n is derived as follows:

tₐᵢ(n)=Max(t_{af}(n−1),t_{ai,earliest}(n)) (C-3)
where t_{ai,earliest}(n) is derived as follows:
   If HRD unit n is not the first HRD unit of a subsequent buffering period, t_{ai,eariest}(n) is derived as follows:

t_{ai,earliest}(n)=t_{r,n}(n) . . . (initial_{—}cpb_removal . . . delay[SchedSelIdx]+initial_{—}cpb_removaldelay_offset[SchedSelIdx])÷90000 (C-4)
with t_{r,n}(n) being the nominal removal time of HRD unit n from the CPB as specified in sub-clause C.1.2 of the HEVC Standard and initial_cpb_removal_delay[SchedSelIdx] and initial_cpb.removal_delay_offset[SchedSelIdx] being specified in the previous buffering period SEI message.
Otherwise (HRD unit n is the first HRD unit of a subsequent buffering period), t_{ai,earliest}(n) is derived as follows:

t_{ai,earliest}(n)=t_{r,n}(n)−(initial_{—}cpb_removal_delay[SchedSelIdx]÷90000) (C-5)
with initial_cpb_removal_delay[SchedSelIdx] being specified in the buffering period SEI message associated with HRD unit n.

The final arrival time for HRD unit n is derived as follows:

t_{af}(n)=t_{a,i}(n)+b(n)÷BitRate[SchedSelIdx] (C-6)

where b(n) is the size in bits of HRD unit n, counting the bits of the VCL NAL units and the filler data NAL units for the Type I conformance point or all bits of the Type II bitstream for the Type II conformance point, where the Type I and Type II conformance points are as shown in FIG. C-1 of the HEVC Standard.

The values of SchedSelIdx, BitRate[SchedSelIdx], and CpbSize[SchedSelIdx] are constrained as follows.
If HRD unit n and HRD unit n−1 are part of different coded video sequences and the content of the active sequence parameter sets of the two coded video sequences differ, the HSS selects a value SchedSelIdx1 of SchedSelIdx from among the values of SchedSelIdx provided for the coded video sequence including HRD unit n that results in a BitRate[SchedSelIdx1] or CpbSize[SchedSelIdx1] for the second of the two coded video sequences (which includes HRD unit n). The value of BitRate[SchedSelIdx1] or CpbSize[SchedSelIdx1] may differ from the value of BitRate[SchedSelIdx0] or CpbSize[SchedSelIdx0] for the value SchedSelIdx0 of SchedSelIdx that was in use for the coded video sequence containing HRD unit n−1.
Otherwise, the HSS continues to operate with the previous values of SchedSelIdx, BitRate[SchedSelIdx] and CpbSize[SchedSelIdx].
   When the HSS selects values of BitRate[SchedSelIdx] or CpbSize[SchedSelIdx] that differ from those of the previous HRD unit, the following applies:
the variable BitRate[SchedSelIdx] comes into effect at time tₐᵢ(n)
the variable CpbSize[SchedSelIdx] comes into effect as follows.
   If the new value of CpbSize[SchedSelIdx] exceeds the old CPB size, it comes into effect at time t_{a,i}(n),
   Otherwise, the new value of CpbSize[SchedSelIdx] comes into effect at the time tᵣ(n).

### Timing of Coded Picture Removal

For HRD unit 0, the nominal removal time of the HRD unit from the CPB is specified as follows:

t_{r,n}(0)=initial_{—}cpb_removal_delay[SchedSelIdx]+90000 (C-7)

For the first HRD unit of a buffering period that does not initialize the HRD, the nominal removal time of the HRD unit from the CPB is specified as follows:

t_{r,n}(n)=t_{r,n}(n_{b})+t_{c}*cpb_removal_delay(n) (C-8)

where t_{r,n}(n_{b}) is the nominal removal time of the first HRD unit of the previous buffering period and cpb_removal_delay(n) is the value of cpb_removal_delay specified in the picture timing SEI message associated with HRD unit n.

When an HRD unit n is the first HRD unit of a buffering period, n_{b} is set equal to n at the removal time of HRD unit n.

The nominal removal time t_{r,n}(n) of an HRD unit n that is not the first HRD unit of a buffering period is given as follows:

t_{r,n}(n)=t_{r,n}(n_{b})+t_{c}*cpb_removal_delay(n) (C-9)

where t_{r,n}(n_{b}) is the nominal removal time of the first HRD unit of the current buffering period and cpb_removal_delay(n) is the value of cpb_removal_delay specified in the picture timing SEI message associated with HRD unit n.
The removal time of HRD unit n is specified as follows.
If low_delay_hrd_flag is equal to 0 or t_{r,n}(n)>=t_{af}(n), then the removal time of HRD unit n is specified as follows:

tᵣ(n)=t_{r,n}(n) (C-10)
Otherwise (low_delay_hrd_flag is equal to 1 and t_{r,n}(n)<t_{af}(n)), the removal time of HRD unit n is specified as follows:

tᵣ(n)=t_{r,n}(n)+t_{c}*Ceil((t_{af}(n)−t_{r,n}(n))÷t_{c}) (C-1)
It is to be appreciated that the latter case indicates that the size of HRD unit n, b(n), is so large that it prevents removal at the nominal removal time.

A description will now be given of some of the many attendant advantages/features of the present invention, some of which have been mentioned above. For example, one advantage/feature is a method in a video decoder. The method includes defining a hypothetical reference decoder timing model to specify timing constraints based on an arrival time and a removal time of hypothetical reference decoder access units included in a video bitstream with respect to a hypothetical reference decoder buffer. The hypothetical reference decoder access units are selected from among a slice access unit and a picture access unit. The method also includes evaluating the video bitstream for conformance to requirements of the hypothetical reference decoder buffer based on the hypothetical reference decoder timing model.

Another advantage/feature is the method as described above, wherein the hypothetical reference decoder timing model determines whether the video bitstream conforms to the requirements of the hypothetical reference decoder buffer under a variable bit rate test case.

Yet another advantage/feature is the method as described above, wherein the hypothetical reference decoder timing model determines whether the video bitstream conforms to the requirements of the hypothetical reference decoder buffer under a constant bit rate test case.

Still another advantage/feature is the method as described above, wherein the hypothetical reference decoder timing model uses a leaky bucket technique to determine whether the video bitstream conforms to the requirements of the hypothetical reference decoder buffer.

Moreover, another advantage/feature is the method as described above, wherein the hypothetical reference decoder timing model is configured to confirm whether the video bitstream conforms to an ultra-low delay mode that constrains a decoding time of a picture to be less than one frame period.

Further, another advantage/feature is the method as described above, wherein activation of the ultra-low delay mode with respect to the video bitstream is based on a flag.

Also, another advantage/feature is the method as described above, wherein the video bitstream is evaluated based on the hypothetical reference decoder timing model being applied with respect to the selected hypothetical reference decoder access units.

Additionally, another advantage/feature is the method wherein the video bitstream is evaluated based on the hypothetical reference decoder timing model being applied with respect to the selected hypothetical reference decoder access units as described above, wherein the video bitstream is evaluated based on the hypothetical reference decoder timing model being applied with respect to statistics of the selected hypothetical reference decoder access units.

Moreover, another advantage/feature is the method as described above, wherein the statistics comprise a bitrate, a size, and a structure of the selected hypothetical reference decoder access units.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture.

Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
receiving at a buffer of a hypothetical reference decoder an access unit of an encoded video bitstream;
defining a timing model to specify an arrival time of the access unit at the buffer and a removal time of the access unit from the buffer;
evaluating (325) the video bitstream for conformance to requirements of the hypothetical reference decoder based on the timing model;
wherein the hypothetical reference decoder determines that the access unit is a slice if an indicator of ultra-low delay mode is set and that the access unit is a picture if the indicator of ultra-low delay mode is not set, and
wherein the hypothetical reference decoder determines an arrival time of the access unit based on an initial arrival time of the access unit and an earliest initial arrival time of the access unit.

2. The method of claim 1, wherein the hypothetical reference decoder determines whether the defined timing model of the video bitstream conforms to the requirements of the hypothetical reference decoder buffer under at least one selected from a group of a variable bit rate test case and a constant bit rate test case.

3. (canceled)

4. The method of claim 1, wherein the hypothetical reference decoder uses a leaky bucket technique to determine whether the defined timing model of the video bitstream conforms to the requirements of the hypothetical reference decoder buffer.

5. The method of claim 1, wherein the hypothetical reference decoder determines whether the defined timing model of the video bitstream conforms to a timing mode that constrains a decoding time of a picture to less than one frame period.

6. (canceled)

7. (canceled)

8. The method of claim 1, wherein the video bitstream is evaluated based on the timing model being applied with respect to statistics of the access units.

9. The method of claim 8, wherein the statistics comprise at least one selected from a group of a bitrate, a size, and a structure of the access unite.

10. An apparatus, comprising:
a hypothetical reference decoder configured to receive at a buffer an access unit of an encoded video bitstream;
wherein the hypothetical reference decoder is configured to define a timing model (277) defined to specify an arrival time of the access unit at the buffer and a removal time of the access unit from the buffer
wherein the hypothetical reference decoder includes a hypothetical reference decoder requirements conformance evaluator (204) for evaluating the video bitstream for conformance to requirements of the hypothetical reference decoder buffer based on the timing model
wherein the hypothetical reference decoder determines that the access unit is a slice if an indicator of ultra-low delay mode is set and that the access unit is a picture if the indicator of ultra-low delay mode is not set, and
wherein the hypothetical reference decoder determines an arrival time of the access unit based on an initial arrival time of the access unit and an earliest initial arrival time of the access unit.

11. The apparatus of claim 10, wherein the hypothetical reference decoder determines whether the defined timing model of the video bitstream conforms to the requirements of the hypothetical reference decoder buffer under at least one selected from a group of a variable bit rate test case and a constant bit rate test case.

12. (canceled)

13. The apparatus of claim 10, wherein the hypothetical reference decoder uses a leaky bucket technique to determine whether the defined timing model of the video bitstream conforms to the requirements of the hypothetical reference decoder buffer.

14. The apparatus of claim 10, wherein the hypothetical reference decoder is configured to confirm whether the defined timing model of the video bitstream conforms to a timing mode that constrains a decoding time of a picture to less than one frame period.

15. The method of claim 1, wherein based upon the determination that the access unit is a slice, a slice buffer temporarily stores temporary slices.

16. The apparatus of claim 10, wherein the video bitstream is evaluated based on the timing model being applied with respect to statistics of the access units.

17. The apparatus of claim 16, wherein the statistics comprise at least one selected from a group of a bitrate, a size, and a structure of the selected hypothetical reference decoder access units.

18. The apparatus of claim 10, wherein based upon the determination that the access unit is a slice, a slice buffer temporarily stores temporary slices.
